(19) United States
(12) Patent Application Publication
(10) Pub. No.: US 2012/0018684 A1
(43) Pub. Date: Jan. 26, 2012

(54) POWDER BLEND

(76) Inventors: Arnold Allenic, Ann Arbor, MI (US); Phillip Gohr, Maumee, OH (US); James Hojnicki, Toledo, OH (US); Michael Latusek, Perrysburg, OH (US); Richard Scott Odneal, Morenci, MI (US); Aaron Roggelin, Millbury, OH (US); Jeffrey Short, Findlay, OH (US); Christopher Wagner, Bowling Green, OH (US)

(21) Appl. No.: 13/189,920

(22) Filed: Jul. 25, 2011

Related U.S. Application Data
(60) Provisional application No. 61/367,134, filed on Jul. 23, 2010.

(51) Int. Cl. H01B 1/02; B65B 1/04; B01F 15/02; H01B 1/06

(52) U.S. Cl. 252/519.4; 252/500; 53/473; 366/189

(57) ABSTRACT

A method for producing uniform powder blends may include a multi-pass riffling process.

### CLAIM OF PRIORITY

This application claims priority under 35 U.S.C. §119(e) to U.S. Provisional Patent Application Ser. No. 61/367,134 filed on Jul. 23, 2010, which is hereby incorporated by reference in its entirety.

### TECHNICAL FIELD

The present invention relates to the production of powder blends and mixtures for photovoltaic modules.

### BACKGROUND

Powder blends and mixtures can be used during the manufacturing of photovoltaic modules. Current methods of producing large quantities of homogenous powder blends and mixtures are inefficient.

### DESCRIPTION OF DRAWINGS

FIG. 1 is a flowchart of a method for producing batches of homogenous powder blends or mixtures.

FIG. 2 is a schematic of a spinning riffler for producing batches of homogenous powder blends or mixtures.

FIG. 3 is a schematic of a spinning riffler for producing batches of homogenous powder blends or mixtures.

FIG. 4 is a diagram of a method for producing batches of homogenous powder blends or mixtures.

### DETAILED DESCRIPTION

Photovoltaic modules can include multiple layers created on a substrate (or superstrate). For example, a photovoltaic module can include a barrier layer, a transparent conductive oxide (TCO) layer, a buffer layer, a semiconductor window layer, and a semiconductor absorber layer, formed in a stack on a substrate. Each layer may in turn include more than one layer or film. For example, the semiconductor window layer and semiconductor absorber layer together can be considered a semiconductor layer. The semiconductor layer can include a first film created (for example, formed or deposited) on the TCO layer and a second film created on the first film. Additionally, each layer can cover all or a portion of the device and/or all or a portion of the layer or substrate underlying the layer. For example, a “layer” can mean any amount of any material that contacts all or a portion of a surface. Each layer can be modified by adding elements chosen for their effect on device performance. Each layer may be formed or deposited by vaporizing a powder in a high throughput deposition system.

Current methods of providing sufficient quantities of doped powder to supply global operations consist of blending various powders on a large scale to yield a nominal final dopant concentration. The final powder may then be shipped to satellite sites. Alternatively, the blending may be performed at each site. These methods, however, have proven expensive and logistically inefficient to execute. It would be desirable to fabricate a concentrate low-mass powder blend from a centralized location, and to supply the low-mass powder blend to satellite manufacturing sites where it can be blended down to produce a finished powder blend with the desired stoichiometry.

Such a method may include a multi-pass riffling process. Two or more powders may be mixed together homogenously in a single large container. The blend or mixture may have any suitable weight, including, for example, more than 2 kg, more than 5 kg, more than 10 kg, or less than 15 kg. For example, the blend or mixture may have a weight of 5 kg. This blend or mixture may be added to the feeder of a spinning riffler where the blend or mixture may be split into homogenous portions of any suitable quantity. For example, a blend or mixture of quantity W may be passed through an N-way riffler. The derived quantities may be passed through the N-way riffler for subsequent divisions, where m defines the total number of division steps. Thus passing a blend or mixture having a quantity W through an N-way riffler for m division steps may yield N^{m} separate blends or mixtures each having a quantity W/N^{m}. For example, a 5 kg homogenous blend may be added to the feeder of a 10-way spinning riffler, where the blend can be split into 10 homogenous portions of approximately 500 g each. Special adapters may be attached to the dividing head to permit further riffling directly into small plastic vials to be used for long-term storage of the blended powder units. The riffling process may be continued for each 500 g portion (i.e., for a second division step where m=2), with each portion being divided into 10 equal units of approximately 50 g each. The end result of the process is 100 vials of homogenous blended powder weighing approximately 50 g produced from a single 5 kg batch of blended powder. The relative standard weights deviation of the final 50 g unit powders may be kept below 0.5% using this multi-pass riffling process. The blends or mixtures may include any of a variety of materials, including, any desired matrix powder or composite. The blend or mixture may also include any suitable dopant. The dopant may be selected from any element in the periodic table, based on its impact on solar module electrical performance. For example, the blends or mixtures may contain cadmium telluride with desired amounts of any suitable dopant, including, for example, silicon or germanium. The blend or powder may include any suitable dry powder material.

Once filled, the vials may be packaged for shipment to satellite sites. Operators at these locations can blend each vial with a quantity (e.g., 10 kg) of powder (e.g., cadmium telluride). The cadmium telluride powder may be substantially pure. The new mixture may be homogenized using any suitable process. For example, a mixture containing a separated blend and a suitable matrix powder may be placed in a container, and tumbled end-over-end. Powder ratios may be adjusted to control the dopant concentration in the finished powder blend. The finished powder blend may be loaded into a high throughput vaporization system for photovoltaic module production.

Module manufacturing using the methods discussed herein can result in gains of more than +0.2% conversion efficiency. These methods may be used to supply satellite sites from a single location, without incurring significant costs. The methods may also be scaled up to support higher capacity operations.

In one aspect, a method of producing a batch of powder mixtures may include combining a plurality of powders to form a homogenous mixture. The method may include feeding the homogenous mixture into a feeder of a spinning riffler. The spinning riffler may include a dividing head comprising a plurality of openings. The method may include dividing the homogenous mixture into a plurality of first-separated mixtures. The method may include depositing each one of the plurality of first-separated mixtures into one of a first plurality of containers. The number of containers in the first plurality of containers may match the number of openings in the dividing head. The method may include feeding each one of the plurality of first-separated mixtures into the feeder. The method may include dividing each one of the plurality of first-separated mixtures into a plurality of twice-separated mixtures. The method may include depositing each one of each of the pluralities of twice-separated mixtures into one of a second plurality of containers. The number of containers in each of the second pluralities of containers may match the number of openings in the dividing head. The number of containers in all second pluralities of containers combined may be defined by the square of the number of openings in the dividing head.

Dividing the homogenous mixture into a plurality of first-separated mixtures may include directing a homogenous mixture of a quantity W into an N-way dividing head of a spinning riffler. Dividing the homogenous mixture into a plurality of first-separated mixtures may include separating the homogenous mixture into N separate mixtures each having a quantity W/N. Dividing each one of the plurality of first-separated mixtures may include directing each one of the plurality of first-separated mixtures into an N-way dividing head of a spinning riffler. Dividing each one of the plurality of first-separated mixtures may include separating each one of the plurality of first-separated mixtures-into N twice-separated mixtures, each having a quantity W/N². Combining a plurality of powders may include mixing at least one matrix powder with at least one dopant. Combining a plurality of powders may include mixing a quantity of cadmium. Combining a plurality of powders may include mixing a quantity of tellurium. Combining a plurality of powders may include mixing a quantity of cadmium telluride. Combining a plurality of powders may include mixing a quantity of silicon. Combining a plurality of powders may include mixing a quantity of germanium. Combining a plurality of powders may include mixing a quantity of tellurium, cadmium, cadmium telluride, silicon, and germanium. The method may include mixing one of each plurality of twice-separated mixtures with a matrix powder to form a final mixture. The method may include homogenizing the final mixture. The homogenizing may include tumbling the final mixture end-over-end.

In another aspect, a method of producing a batch of powder mixtures may include combining a plurality of powders to form a homogenous mixture of quantity W. The method may include dividing the homogenous mixture into N separate mixtures. The method may include repeating the dividing step m−1 times, such that each subsequent dividing step includes dividing at least one of the N separate mixtures into another N separate mixtures. The dividing and repeating steps may yield a total of N^{m} separate mixtures, each having a quantity W/N^{m}. Each dividing step may include passing a quantity of the homogenous mixture through a spinning riffler. Combining a plurality of powders may include forming a quantity of more than 1 kg. Combining a plurality of powders may include forming a quantity of less than 10 kg. Each dividing step may include separating at least a portion of the homogenous mixture into 2 or more separate mixtures. Each dividing step may include separating at least a portion of the homogenous mixture into 20 or less separate mixtures. The repeating may include executing 1 or more dividing steps in addition to the first dividing step. The repeating may include executing 5 or less dividing steps in addition to the first dividing step. Combining a plurality of powders may include mixing a quantity of tellurium, cadmium, cadmium telluride, silicon, and germanium. Combining a plurality of powders may include mixing at least one matrix powder with at least one dopant. The method may include mixing at least one of the N^{m} separate mixtures with a matrix powder to form a final mixture. The method may include homogenizing the final mixture. The homogenizing may include tumbling the final mixture end-over-end.

In another aspect, a powder blend can include a first powder comprising a first amount of a first material and a second powder comprising a second amount of the first material and a dopant amount of dopant, wherein the dopant amount is between about 0.1% and about 2.0% by weight of the second amount, and the second amount is between about 0.1% and about 2.0% of the first amount.

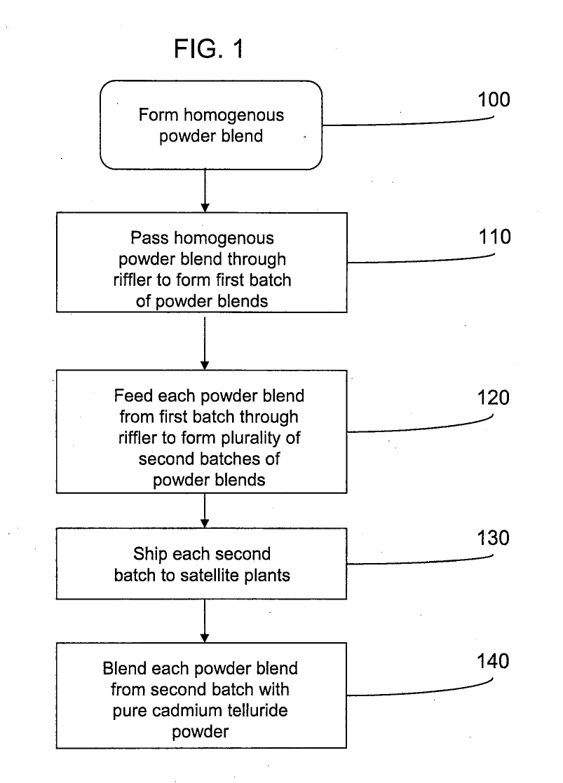

FIG. 1 contains a flow chart describing the various steps included in the improved powder manufacturing method discussed herein. At step 100, a homogenous powder may be formed in a single container. The homogenous powder may consist of two or more powders blended or mixed together. The homogenous powders may be mixed or blended using any suitable means or techniques. The homogenous powder may include any suitable substance or material, including, for example, any material suitable for forming one or more layers of a photovoltaic module. For example, the homogenous powder may include any suitable matrix powder. The matrix powder may include one or more impurities, which may include any suitable element. For example, the homogenous powder may include cadmium, tellurium, cadmium telluride, combined with desired quantities of silicon, germanium, or any other suitable dopant. The homogenous powder may be of any suitable sized quantity. For example, the homogenous powder may have a weight of more than 1 kg, more than 3 kg, more than 5 kg, or less than 10 kg. For example, the homogenous powder may include 5 kg of a mixture including cadmium and tellurium. At step 110, the homogenous powder may be passed through a riffler to form a first batch of powder blends or mixtures. Any suitable riffler may be used to divide the homogenous powder into a batch of separated blends or mixtures. For example, any suitable commercial riffler, having a spinning head and a feeder, may be used.

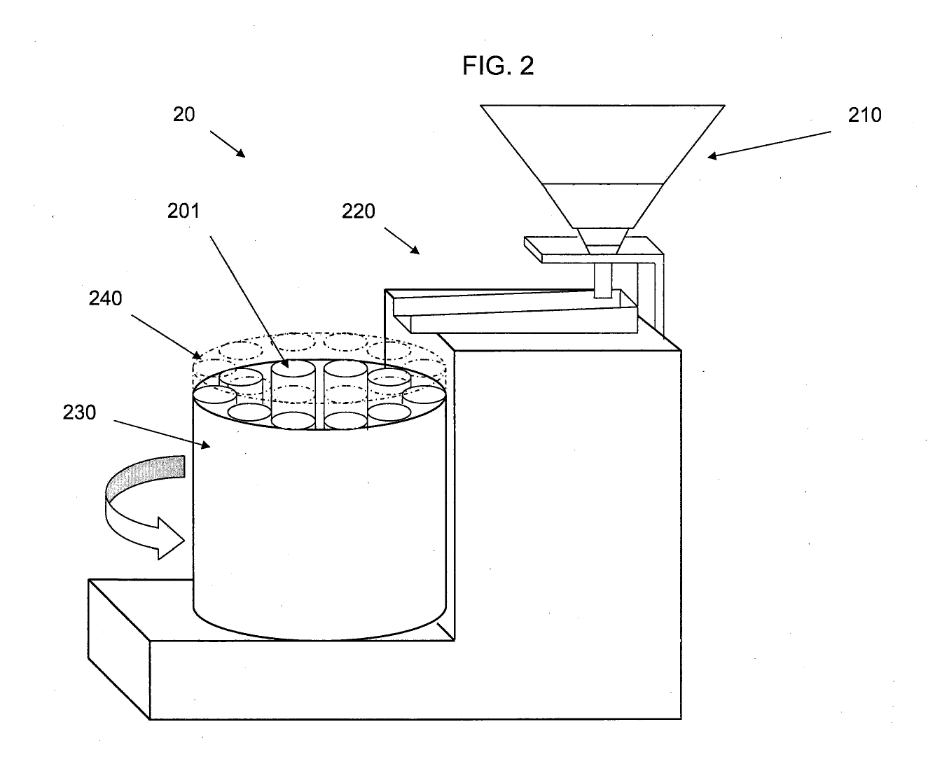

FIG. 2 depicts an exemplary riffler 20 for dividing the homogenous powder into multiple smaller quantities. Riffler 20 may contain a hopper 210 configured to receive a powder. Hopper 210 can funnel the powder into feeder 220. Feeder 220 may be configured to feed a powder received from hopper 210 into one or more openings of a dividing head 240 positioned on a drum 230. Feeder 220 may be adjusted to control the speed at which the powder is deposited into one or more openings of dividing head 240. Drum 230 may include one or more vials 201 positioned beneath dividing head 240. Dividing head 240 may feed each of the plurality of separated powders into a separate vial 201. Dividing head 240 may contain any suitable number of openings to yield the desired number of separated powders. For example, dividing head 240 may include 5 or more openings, or more than 10 openings. The number of vials 201 included in drum 230 may correspond to the number of openings in dividing head 240. For example, dividing head 240 may consist of a 10-way dividing head, under which 10 vials 201 may be situated to collect the 10 separated powders. Drum 230 may be configured to spin as powder from feeder 220 is directed toward dividing head 240. Drum 230 may be configured to spin clockwise or counter-clockwise and may be configured to spin at any suitable speed for any suitable duration. Riffler 20 may include any suitable means to permit spinning of drum 230, including, for example, a DC motor. For example, drum 230 may be configured to spin in a clockwise direction via a DC motor; as drum 230 spins, powder received from feeder 220 may pass into any one of the openings of dividing head 240. As more powder is fed through feeder 220, and as drum 230 continues to spin, portions of powder may enter each opening or separation of dividing head 240. Dividing head 240 may continuously pass powder received in each of its divisions into any vial 201. Thus riffler 20 may ensure even distribution of a deposited powder. Riffler 20 may ensure that a homogenous mixture or blend deposited into hopper 210 is evenly distributed such that the contents of each vial 201 are substantially homogenous. The contents distributed into each vial 201 can have a substantially similar homogeneity to the original, larger homogenous powder deposited into hopper 210.

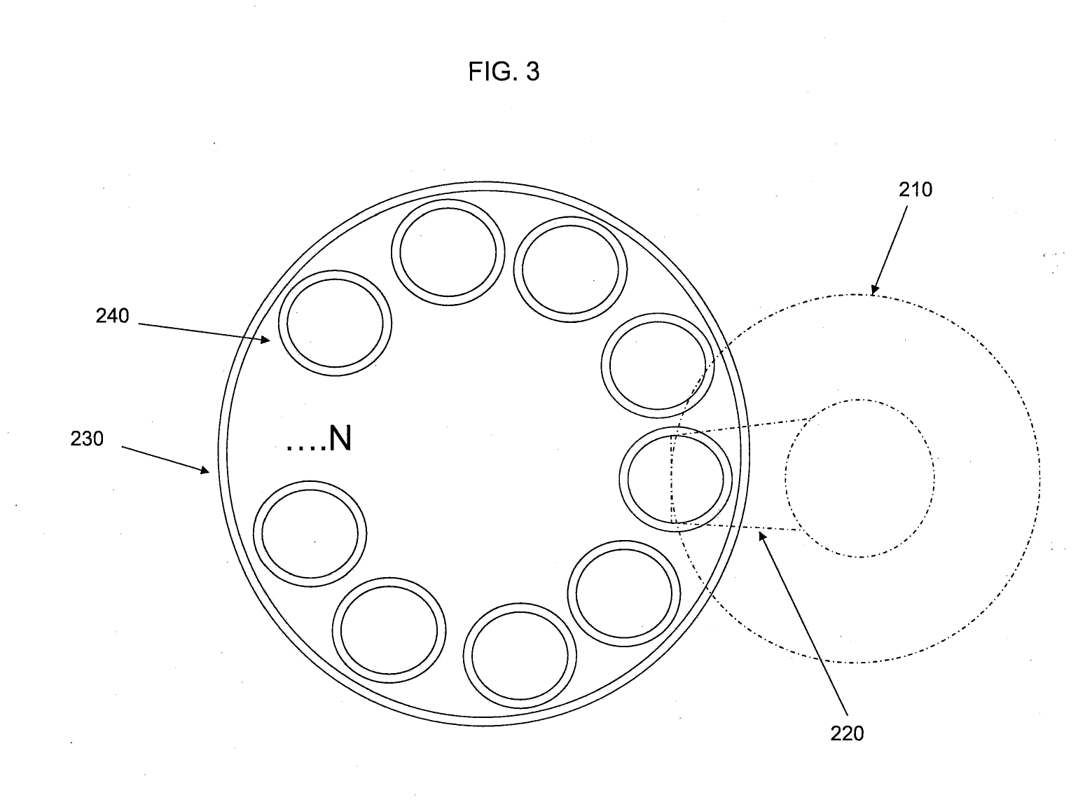

FIG. 3 depicts an overhead view of exemplary riffler 20 from FIG. 2. Feeder 220 is positioned such that the point of exit for a powder deposited into feeder 220 is positioned directly above an opening of dividing head 240. Feeder 220 and dividing head 240 can be positioned such that following one full 360 degree rotation of drum 230, the exit point of feeder 220 will have been positioned above each opening within dividing head 240 to permit powder flowing from feeder 220 to enter any one of the openings of dividing head 240. Non-open portions of dividing head 240 which may be exposed to falling powder may be minimized to ensure that nearly all of powder flowing from feeder 220 enters through one of the openings of dividing head 240. Riffler 20 may yield any desired number of separated blends or mixtures. The number of mixtures or blends produced by riffler 20 may correspond to the number of openings in the dividing head 240 and/or to the number of vials 201 positioned within drum 230. The plurality of blends or mixtures produced by riffler 20 may define a first batch of mixtures or blends. The first batch of mixtures or blends may include any desired quantity of powders, including, for example, more than 5, more than 10, or less than 15 separate, uniform powder blends or mixtures. The first batch of mixtures or blends may contain one or more vials 201. Each vial 201 of the first batch may contain any suitable quantity of powder, including, for example, more than 100 g, more than 250 g, less than 750 g, or less than 500 g.

Referring back to FIG. 1, at step 120, each blend or mixture from the first batch may be passed through a riffler to obtain a second batch of mixtures or blends. The quantities of powders included in the second batch may be substantially smaller than each powder blend or mixture from the first batch. The quantity of powder in a vial from the second batch may be related to the quantity of powder in the first batch by a factor defined by the number of openings in the dividing head of the riffler, or the number of vials in the drum of the riffler. The contents of each vial from the first batch may be passed through the riffler, yielding a corresponding second batch to each vial from the first batch. Thus the first batch may be passed through the riffler to yield multiple second batches of powder. Each vial of the second batch may contain any suitable quantity of powder, including, for example, more than 10 g, more than 40 g, more than 100 g, less than 500 g, or less than 250 g. For example, each vial from a second batch of powders may have about 50 g of powder.

At step 130, the vials from the second batches may be sent to various satellite plants. At step 140, vials from the second batches may be mixed or blended with one or more other powders. For example, a vial of powder from a second batch may be blended with a pure cadmium telluride. The vials from the second batch may be mixed or blended with any suitable quantity of pure cadmium telluride powder, including, for example, more than 5 kg, more than 8 kg, or less than 15 kg of pure cadmium telluride powder. The powder ratios may be adjusted to control the dopant concentration in the finished powder blend. The resulting powder may be loaded into a high-throughput vaporization system for photovoltaic module production. The resulting powder may have suitable properties for desired coater operations. The resulting powder may provide an overall gain in photovoltaic module efficiency. For example, the resulting powder may be responsible for a +0.3% gain in module efficiency.

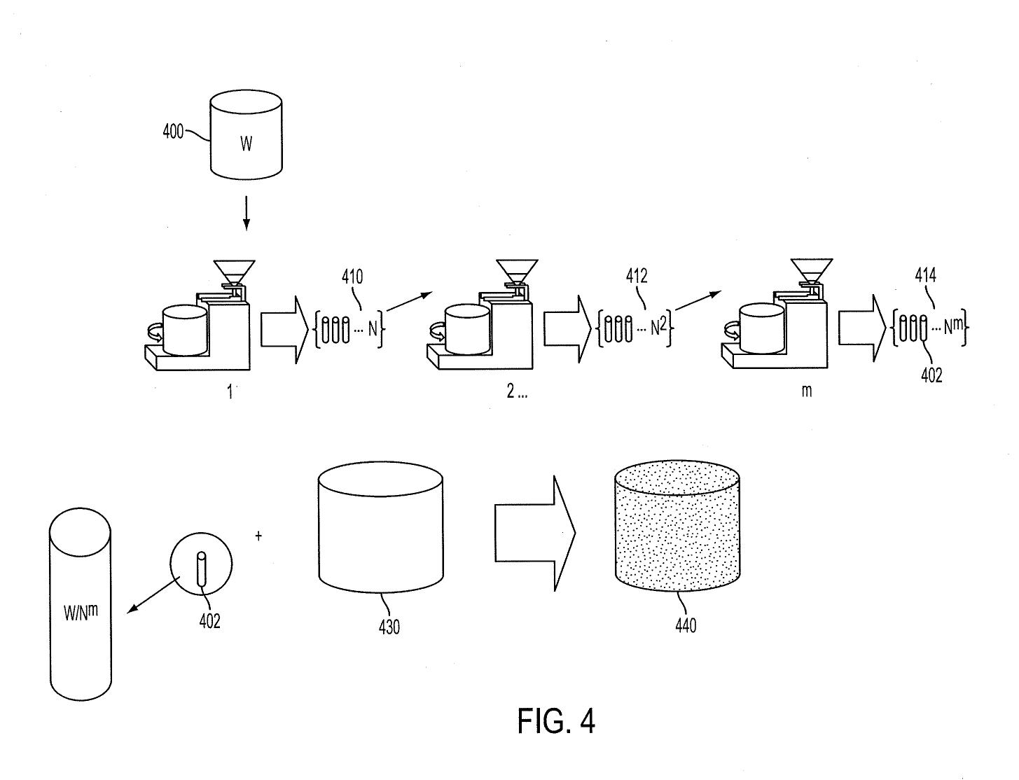

FIG. 4, which illustrates some of the steps shown in the FIG. 1 flowchart, depicts a homogenous powder 400 of quantity W, which may be passed through a riffler, to undergo a first riffling process. The first riffling process may yield a first batch 410 of N homogenous powders, divided into quantities substantially smaller than homogenous powder 400. First batch 410 may include a plurality of containers. The plurality of containers may include any suitable number of containers, including N containers. Each container may contain any desired portion of homogenous powder 400. The quantity of powder in each container from the plurality of containers can be defined by WIN. For example, a homogenous powder 400 including 5 kg of powder may yield 10 containers of 500 g each after being passed through a riffler having a dividing head of 10 openings. Each container from first batch 410 may undergo a second riffling process, yielding a plurality of second batches 412 of homogenous powders, each divided into quantities substantially smaller than the portion of homogenous powder 400 in each container from first batch 410. Second batch 412 may include a plurality of containers, each containing a portion of homogenous powder 400 defined by W/N². Each container of each second batch 412 may be shipped to a satellite site, where its contents may be mixed or blended with other powders (e.g., a matrix powder, such as a pure cadmium telluride) to obtain a finished powder blend. The finished powder blend may be a suitable material for the production of various layers of a photovoltaic module. Alternatively, each container from second batch 412 may undergo one or more additional riffling processes. The containers derived from each riffling process may either be packaged or separated again, depending on the desired number of mixtures. The entire process may culminate in final riffling process m, where m defines the number of times homogenous powder 400 is divided. Each container 402 of the final batch 414 may have a quantity W/N^{m}. One or more containers 402 may be mixed with a matrix powder 430 for further processing. For example, contents of a container 402 may be added to a fixed amount of “matrix powder,” which may include any suitable substance, including, for example, cadmium telluride. The weight of the cadmium telluride can be adjusted to obtain the desired dopant concentration in the finished powder blend. The final mixture 440 can be tumbled end-over-end to homogenize the mixture.

Blends or mixtures processed using the methods discussed herein may be used during the fabrication of one or more photovoltaic cells, which may be incorporated into one or more photovoltaic modules. For example, blends or mixtures processed using the aforementioned methods may be used to deposit one or more photovoltaic device layers (e.g., cadmium telluride) onto a substrate to create a photovoltaic cell. Photovoltaic cells fabricated therefrom may be incorporated into one or more photovoltaic modules, which may include one or more submodules. The photovoltaic modules may by incorporated into various systems for generating electricity. For example, a photovoltaic module may include one or more submodules consisting of multiple photovoltaic cells connected in series. One or more submodules may be connected in parallel via a shared cell to form a photovoltaic module.

A bus bar assembly may be attached to a contact surface of a photovoltaic module to enable connection to additional electrical components (e.g., one or more additional modules). For example, a first strip of double-sided tape may be distributed along a length of the module, and a first lead foil may be applied adjacent thereto. A second strip of double-sided tape (smaller than the first strip) may be applied adjacent to the first lead foil. A second lead foil may be applied adjacent to the second strip of double-sided tape. The tape and lead foils may be positioned such that at least one portion of the first lead foil is exposed, and at least one portion of the second lead foil is exposed. Following application of the tape and lead foils, a plurality of bus bars may be positioned along the contact region of the module. The bus bars may be positioned parallel from one another, at any suitable distance apart. For example, the plurality of bus bars may include at least one bus bar positioned on a portion of the first lead foil, and at least one bus bar positioned on a portion of the second lead foil. The bus bar, along with the portion of lead foil on which it has been applied, may define a positive or negative region. A roller may be used to create a loop in a section of the first or second lead foil. The loop may be threaded through the hole of a subsequently deposited back glass. The photovoltaic module may be connected to other electronic components, including, for example, one or more additional photovoltaic modules. For example, the photovoltaic module may be electrically connected to one or more additional photovoltaic modules to form a photovoltaic array.

The photovoltaic cells/modules/arrays may be included in a system for generating electricity. For example, a photovoltaic cell may be illuminated with a beam of light to generate a photocurrent. The photocurrent may be collected and converted from direct current (DC) to alternating current (AC) and distributed to a power grid. Light of any suitable wavelength may be directed at the cell to produce the photocurrent, including, for example, more than 400 nm, or less than 700 nm (e.g., ultraviolet light). Photocurrent generated from one photovoltaic cell may be combined with photocurrent generated from other photovoltaic cells. For example, the photovoltaic cells may be part of one or more photovoltaic modules in a photovoltaic array, from which the aggregate current may be harnessed and distributed.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

1. A method of producing a batch of powder mixtures:
combining a plurality of powders to form a homogenous mixture;
feeding the homogenous mixture into a feeder of a spinning riffler, wherein the spinning riffler comprises a dividing head comprising a plurality of openings;
dividing the homogenous mixture into a plurality of first-separated mixtures;
depositing each one of the plurality of first-separated mixtures into one of a first plurality of containers, wherein the number of containers in the first plurality of containers matches the number of openings in the dividing head;
feeding each one of the plurality of first-separated mixtures into the feeder;
dividing each one of the plurality of first-separated mixtures into a plurality of twice-separated mixtures; and
depositing each one of each of the pluralities of twice-separated mixtures into one of a second plurality of containers, wherein the number of containers in each of the second pluralities of containers matches the number of openings in the dividing head, and wherein the number of containers in all second pluralities of containers combined is defined by the square of the number of openings in the dividing head.

2. The method of claim 1, wherein dividing the homogenous mixture into a plurality of first-separated mixtures comprises directing a homogenous mixture of a quantity W into an N-way dividing head of a spinning riffler.

3. The method of claim 2, wherein dividing the homogenous mixture into a plurality of first-separated mixtures further comprises separating the homogenous mixture into N separate mixtures each comprising a quantity W/N.

4. The method of claim 1, wherein dividing each one of the plurality of first-separated mixtures comprises directing each one of the plurality of first-separated mixtures into an N-way dividing head of a spinning riffler.

5. The method of claim 4, wherein dividing each one of the plurality of first-separated mixtures comprises separating each one of the plurality of first-separated mixtures into N twice-separated mixtures, each comprising a quantity W/N².

6. The method of claim 1, wherein combining a plurality of powders comprises mixing at least one matrix powder with at least one dopant.

7. The method of claim 1, wherein combining a plurality of powders comprises mixing a quantity of cadmium.

8. The method of claim 1, wherein combining a plurality of powders comprises mixing a quantity of tellurium.

9. The method of claim 1, wherein combining a plurality of powders comprises mixing a quantity of cadmium telluride.

10. The method of claim 1, wherein combining a plurality of powders comprises mixing a quantity of silicon.

11. The method of claim 1, wherein combing a plurality of powders comprises mixing a quantity of germanium.

12. The method of claim 1, wherein combining a plurality of powders comprises mixing a quantity selected from the group consisting of tellurium, cadmium, cadmium telluride, silicon, and germanium.

13. The method of claim 1, further comprising mixing one of each plurality of twice-separated mixtures with a matrix powder to form a final mixture.

14. The method of claim 13, further comprising homogenizing the final mixture.

15. The method of claim 14, wherein the homogenizing comprises tumbling the final mixture end-over-end.

16. A method of producing a batch of powder mixtures, the method comprising:
combining a plurality of powders to form a homogenous mixture of quantity W;
dividing the homogenous mixture into N separate mixtures; and
repeating the dividing step m−1 times, such that each subsequent dividing step comprises dividing at least one of the N separate mixtures into another N separate mixtures; and
wherein the dividing and repeating steps yield a total of N^{m} separate mixtures, each comprising a quantity W/N^{m}.

17. The method of claim 16, wherein each dividing step comprises passing a quantity of the homogenous mixture through a spinning riffler.

18. The method of claim 16, wherein combining a plurality of powders comprises forming a quantity of more than 1 kg.

19. The method of claim 16, wherein combining a plurality of powders comprises forming a quantity of less than 10 kg.

20. The method of claim 16, wherein each dividing step comprises separating at least a portion of the homogenous mixture into 2 or more separate mixtures.

21. The method of claim 16, wherein each dividing step comprises separating at least a portion of the homogenous mixture into 20 or less separate mixtures.

22. The method of claim 16, wherein the repeating comprises executing 1 or more dividing steps in addition to the first dividing step.

23. The method of claim 16, wherein the repeating comprises executing 5 or less dividing steps in addition to the first dividing step.

24. The method of claim 16, wherein combining a plurality of powders comprises mixing a quantity selected from the group consisting of tellurium, cadmium, cadmium telluride, silicon, and germanium.

25. The method of claim 16, wherein combining a plurality of powders comprises mixing at least one matrix powder with at least one dopant.

26. The method of claim 16, further comprising mixing at least one of the N^{m} separate mixtures with a matrix powder to form a final mixture.

27. The method of claim 26, further comprising homogenizing the final mixture.

28. The method of claim 27, wherein the homogenizing comprises tumbling the final mixture end-over-end.

29. A powder blend comprising:
a first powder comprising a first amount of a first material;
a second powder comprising a second amount of the first material and a dopant amount of dopant, wherein the dopant amount is between about 0.1% and about 2.0% by weight of the second amount, and the second amount is between about 0.1% and about 2.0% of the first amount.

30. The powder blend of claim 29, wherein the first material comprises cadmium telluride.
